(19) United States
(12) Patent Application Publication
(10) Pub. No.: US 2012/0198684 A1
(43) Pub. Date: Aug. 9, 2012

(54) METHODS OF MICROPATTERNING PAPER-BASED MICROFLUIDICS

(75) Inventors: Emanuel Carrilho, Chestnut Hill, MA (US); Andres W. Martinez, Cambridge, MA (US); George M. Whitesides, Newton, MA (US)

(73) Assignee: PRESIDENT AND FELLOWS OF HAARVARD COLLEGE, CAMBRIDGE, MA (US)

(21) Appl. No.: 13/254,958

(22) PCT Filed: Mar. 8, 2010
(86) PCT No.: PCT/US10/26547

§ 371 Date: Apr. 23, 2012

Related U.S. Application Data
(60) Provisional application No. 61/158,248, filed on Mar. 6, 2009.

(51) Int. Cl. B23P 25/00

(52) U.S. Cl. 29/527.1

(57) ABSTRACT

Methods of patterning hydrophobic regions onto hydrophilic substrates are described.

### CROSS REFERENCE TO RELATED APPLICATIONS

This application claims the benefit of U.S. Provisional Application No. 61/158,248, filed Mar. 6, 2009, the entire contents of which are hereby incorporated by reference herein.

### BACKGROUND

The analysis of biological fluids is useful for monitoring the health of individuals and populations. However, these measurements can be difficult to implement in remote regions such as those found in developing countries, in emergency situations, or in home health-care settings. Conventional laboratory instruments provide quantitative measurements of biological samples, but they are typically unsuitable for remote locations since they are large, expensive, and typically require trained personnel and considerable volumes of biological samples.

Paper-based microfluidic analytical devices are typically small, portable, and fabricated from inexpensive materials. Because they can operate without any supporting equipment, they are well-suited for diagnostic applications in developing countries, in the field by first responders, or in home healthcare settings.

### SUMMARY OF INVENTION

Methods of patterning porous, hydrophilic substrates into hydrophobic and hydrophilic regions are described. In one aspect, the invention features a method of patterning a porous, hydrophilic substrate into hydrophobic and hydrophilic regions, the method comprising disposing a wax material onto the hydrophilic substrate in a predetermined pattern; and heating the substrate to a temperature sufficient to melt the wax material, the melted wax material substantially permeating the thickness of the substrate and defining a pattern of one or more hydrophobic regions.

In one or more embodiments, the substrate is heated to a temperature of about 120° C. to about 180° C. In some embodiments, after heating the substrate, the wax permeates the entire thickness of the substrate.

In one or more embodiments, the porous, hydrophilic substrate is patterned into an array of assay units. In particular embodiments, each assay unit comprises a fluid impervious barrier comprising the wax, the barrier substantially permeating the thickness of the porous, hydrophilic substrate and defining a boundary of an assay region within the porous, hydrophilic substrate; and an assay reagent in the assay region.

In yet other embodiments, the barrier further defines a boundary of a channel region within the porous, hydrophilic substrate, the channel region fluidically connected to the assay region. In one ore more embodiments, the barrier further defines a boundary of a sample deposition region within the porous, hydrophilic substrate, the channel providing a fluidic pathway within the porous, hydrophilic substrate between the sample deposition region and the assay region. In one or more embodiments, the barrier further defines boundaries of a plurality of assay regions.

In one or more embodiments, the porous, hydrophilic substrate is nitrocellulose, cellulose acetate, filter paper, cloth, porous polymer film, or glass fiber paper. In some embodiments, the porous, hydrophilic substrate is paper. In particular embodiments, the paper is chromatography paper.

In one or more embodiments, the wax material is disposed onto the paper at a width of about 100 μm to about 1500 μm. In one more embodiments, after the heating step, the wax material comprises a line thickness of about 700 μm to about 1400 μm.

In one or more embodiments, the disposing step comprises hand drawing, printing, or stamping. In some embodiments, the disposing step comprises printing using a solid ink printer.

In another aspect, the invention features a method of patterning paper into hydrophobic and hydrophilic regions, the method comprising: printing a solid ink onto the paper in a predetermined pattern using a solid ink printer; and heating the paper to a temperature sufficient to melt the solid ink, the ink substantially permeating the thickness of the paper and defining a pattern of one or more hydrophobic regions.

In some embodiments, the paper is heated to a temperature of about 120° C. to about 180° C. In one or more embodiments, the paper is chromatography paper.

In one or more embodiments, the solid ink is printed at a line thickness of about 200 μm to about 800 μm. In some embodiments, after the heating step, the solid ink comprises a line thickness of about 700 μm to about 1400 μm.

In one or more embodiments, the paper is patterned into an array of assay units. In some embodiments, each assay unit comprises a fluid impervious barrier comprising the solid ink, the barrier substantially permeating the thickness of the paper and defining a boundary of an assay region within the paper; and an assay reagent in the assay region.

In yet other embodiments, the barrier further defines a boundary of a channel region within the paper, the channel region fluidically connected to the assay region. In one ore more embodiments, the barrier further defines a boundary of a sample deposition region within the paper, the channel providing a fluidic pathway within the paper between the sample deposition region and the assay region. In one or more embodiments, the barrier further defines boundaries of a plurality of assay regions.

### BRIEF DESCRIPTION OF THE DRAWINGS

FIG. 1A is a schematic representation of a wax printing method. FIG. 1B is a digital image of a test design for wax printing. FIG. 1C is a digital image of the test design printed onto Whatman no. 1 chromatography paper using a solid ink printer. FIG. 1D arc digital images of the test design after heating the paper.

FIG. 2A is a schematic representation of the spreading of molten wax in paper. FIG. 2B is a series of optical micrographs comparing the front, back, and cross-sectional views of printed horizontal lines “before” and “after” the melting process. FIG. 2C is a graph of the quantitative assessment of the spreading of molten wax in chromatography paper.

FIG. 3A is an illustration of a μPAD with horizontal barriers. FIG. 3B is an illustration of a μPAD with vertical barriers. FIG. 3C is a μPAD with circular hydrophobic barriers. FIG. 3D is a μPED with channels.

FIG. 4A is an illustration of a 96-zone plate with microfluidic channels fabricated by wax printing. FIG. 4B is an illustration of a 384-zone plate fabricated by wax printing. FIG. 4C is an illustration of a μPAD fabricated by wax printing for detecting protein, cholesterol, and glucose in biological fluids. FIG. 4D is an illustration of a 3D μPAD fabricated by wax printing.

### DETAILED DESCRIPTION

All publications, patent applications, patents, and other references mentioned herein, are incorporated by reference in their entirety. Unless otherwise defined, all technical and scientific terms used herein have the same meaning as commonly understood by one of ordinary skill in the art to which this invention belongs. In case of conflict, the present specification, including definitions, will control. In addition, the materials, methods, and examples are illustrative only and not intended to be limiting. Although methods and materials similar or equivalent to those described herein can be used in the practice or testing of the present invention, suitable methods and materials arc described below.

Other features and advantages of the invention will be apparent from the following detailed description, and from the claims.

The invention is based, at least in part, on the discovery of a new process for patterning porous, hydrophilic substrates, such as paper, into hydrophobic and hydrophilic regions by disposing a wax material onto a hydrophilic substrate and heating the substrate to melt the wax. In certain embodiments, such patterning processes can be used to produce microfluidic paper-based analytical devices (μPADs), such as those described in WO2008/049083.

The methods described herein generally involve two steps. The first step includes contacting or disposing a wax material onto a porous, hydrophilic substrate, such as paper. The wax material can be contacted or disposed onto the hydrophilic substrate in a number of ways, such as by hand-drawing, printing, or stamping, as described herein.

The second step of the methods described herein involves heating the layer of wax material on the surface of the hydrophilic substrate to a temperature sufficient to melt the wax material to provide fluid flow. The heating step results in the spreading of the wax material three-dimensionally throughout the porous, hydrophilic substrate. For example, the heating can result in the wax material spreading through the hydrophilic substrate, substantially permeating the thickness of the hydrophilic substrate and defining hydrophobic barriers within the hydrophilic substrate. In particular embodiments, the heating results in the wax material spreading through the entire thickness of the hydrophilic substrate, such that the wax material forms a hydrophobic barrier from a first face of the hydrophilic substrate through the entire thickness of the substrate to a second face of the hydrophilic substrate. A sufficient temperature can be determined by those of ordinary skill in the art and can depend on the composition and thickness of the wax material, the dimensions of the hydrophilic substrate, and the deposition technique.

One aspect of this method is that hydrophobic material is applied only where a barrier is needed, thereby minimizing material costs and reducing contamination of hydrophilic regions. Thus, this method is easier than other methods such as photolithography. By not contacting the hydrophilic substrate with hydrophobic substances, there is no need to subsequently oxidize the surface with plasma, as required in standard photolithography processes to remove hydrophobic screen layers from the surface of the hydrophilic substrate.

Hydrophilic Substrates

Any porous, hydrophilic substrate can be used in the methods described herein, and the choice of substrate can be dictated by the contemplated application. For example, paper is a known platform for biological assays and diagnostic devices. Paper is an inexpensive and porous matrix. Solutions can be adsorbed by paper and moved around the paper by capillary action. Liquid movement within paper and related porous matrices serves as a foundation for many existing applications (e.g., portable assays, diagnostic devices, chromatography, blots, etc.). Liquid movement within paper can be controlled if paper is equipped with patterned hydrophobic features. This patterning has been demonstrated previously using photolithography techniques (see, e.g., WO2008/049083). Further, positional control of wetting allows for fabrication of complex microfluidic paper-based devices for bioassays and diagnostics (see, e.g., WO2008/049083).

While many of the embodiments described herein include the use of paper as the porous, hydrophilic substrate, any substrate that absorbs hydrophilic solutions can be used, e.g., nitrocellulose and cellulose acetate, filter paper, cloth, porous polymer film, and glass fiber paper.

Wax Materials

As used herein, “wax material” means a lipophilic compound that is solid at ambient temperature (around 25° C.), exhibits a reversible solid/liquid state change, and has a melting point between about 45° C. and about 150° C. By converting the wax to a liquid state (i.e., by melting the wax), the wax can flow through a porous, hydrophilic substrate described herein, and subsequently converting the wax to a solid state (i.e., by cooling the wax) the wax can form a solid hydrophobic barrier within the porous, hydrophilic substrate.

Nonlimiting examples of waxes useful in the methods described herein include, e.g., insect waxes, vegetable waxes, mineral waxes, petroleum waxes, microcrystalline waxes, synthetic waxes, or combinations thereof. Other nonlimiting examples include, e.g., beeswax, carnauba wax, candelilla wax, paraffin, ceresin, ozokerite, polyethylene waxes, Fischer-Tropsch waxes, and silicone waxes such as alkyl- or alkoxy-dimethicones having 16 to 45 carbon atoms.

In particular embodiments, the wax material is a solid ink or a phase change ink, such as one described in U.S. Pat. No. 6,319,310; U.S. Pat. No. 6,642,408; or U.S. Publ. No. 2006/0130054. In one or more embodiments, the wax material is a solid ink available from Xerox Corp.

Methods of Disposing Wax Materials onto Hydrophilic Substrates

Any suitable process for contacting or disposing a wax material onto a hydrophilic substrate can be used in the methods described herein. For example, a wax material can be hand-drawn, printed, or stamped onto a hydrophilic substrate. In one or more embodiments, a wax material is patterned onto a porous, hydrophilic substrate by hand, such as using a wax crayon or a wax pen. In some instances, a wax pattern can be drawn freehand onto the porous, hydrophilic substrate. In other situations, a standard printer can be used to print a pattern onto a porous, hydrophilic substrate, and the pattern can then be traced using a wax material (such as using a wax crayon or wax pen).

In embodiments where the wax material is a solid ink or a phase change ink, the ink can be disposed onto paper using a paper printer. Particular printers that can use solid inks or phage change inks are known in the art and are commercially available. One exemplary printer is a Phaser™ printer (Xerox Corporation). In such embodiments, the printer disposes the wax material onto paper by initially heating and melting the solid ink to print a preselected pattern onto the paper. The printed paper is subsequently heated to melt the wax material (solid ink) to form hydrophobic barriers, as described herein.

In such embodiments, computer-assisted design can be used to determine a preselected pattern. For example, a pattern can be designed using a suitable computer graphics program, and the pattern can be subsequently printed using a solid ink printer. Such computer-assisted design can be used to consistently reproduce a pattern several times on multiple sheets of paper and/or several times on a single sheet of paper. In certain embodiments, this method can be used to produce tens, hundreds, or thousands of μPADs on a single sheet of paper.

In certain embodiments, one side of the hydrophilic substrate is contacted, e.g., printed, with a wax material. In other embodiments, both sides of a hydrophilic substrate are contacted, e.g., printed, with a wax material. For example, the wax material can be printed onto a first face of a hydrophilic substrate using a pattern and can be printed onto the opposite face of the hydrophilic substrate using the mirror image of the pattern. In such embodiments, following heating, the wax melts and permeates from each face of the hydrophilic substrate into the thickness of the hydrophilic substrate, resulting in the same pattern of wax through the entire thickness of the hydrophilic substrate.

The wax material can be disposed onto a hydrophilic substrate in any predetermined pattern, and the feature sizes can be determined by the pattern and/or the thickness of the substrate. For example, a μPAD can be produced by printing wax lines onto paper (e.g., chromatography paper), using a solid ink printer. The dimensions of the wax lines can be determined by the feature sizes of the μPAD and/or the thickness of the paper. For example, the wax material can be printed onto paper at a line thickness of about 100 about 200 μm, about 300 μm, about 400 μm, about 500 about 600 μm, about 700 μm, about 800 μm, about 900 μm, about 1 mm, or thicker. The thickness of the wax to be printed can be determined by, e.g., analyzing the extent to which the wax permeates through the thickness of the substrate after heating, as described herein.

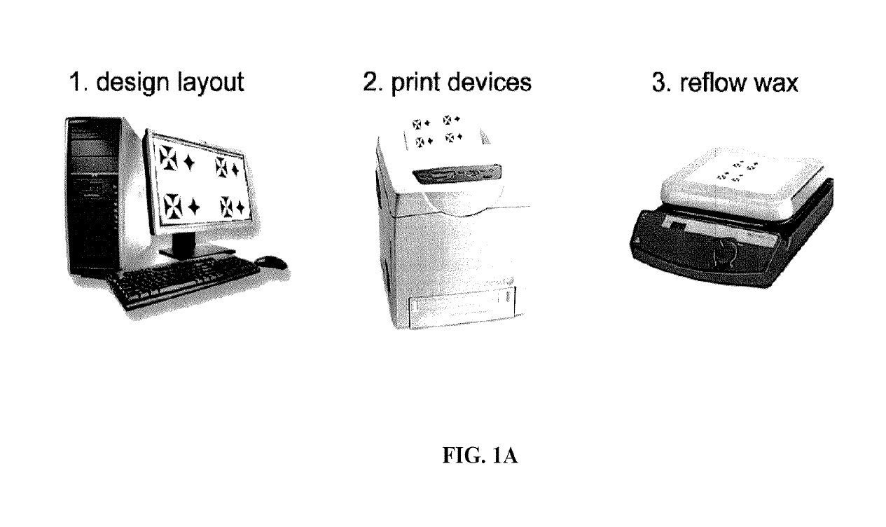

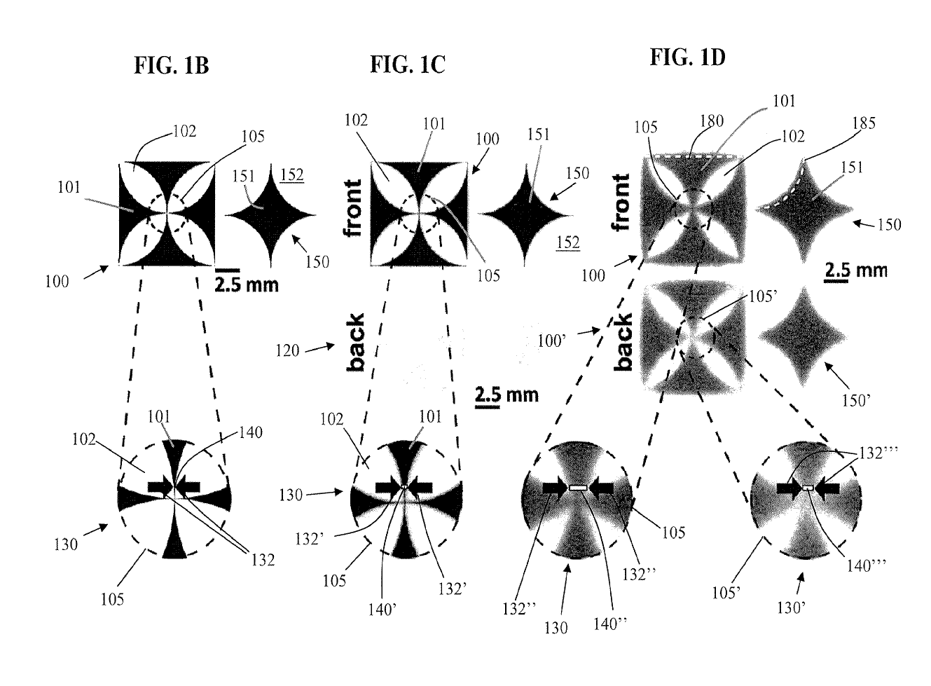

One exemplary method of using a printer to pattern paper is illustrated in FIG. 1. As shown in step 1 of FIG. 1A, a computer program is first used to design a layout or pattern of solid ink to be disposed onto paper. In step 2 of FIG. 1A, a solid ink printer is used to print wax onto the paper based on the design. The printer initially heats and melts the solid ink to print the design onto paper. Finally, in step 3 of FIG. 1A, a hot plate is used to melt (reflow) the wax to such that the wax substantially permeates the thickness of the paper to form hydrophobic barriers within the paper.

FIG. 1B illustrates two digital designs, 100 and 150, designed with a computer program. Design 100 includes ink region 101, onto which solid ink is to be printed, and paper region 102, where no solid ink is to be printed. Illustrated as 130 is a magnification of central region 105 of design 100. The width of ink region 101 between arrows 132 is indicated as area 140. Design 150 includes ink region 151, onto which solid ink is to be printed, surrounded by paper region 152, where no solid ink is to be printed.

FIG. 1C illustrates the printing of designs 100 and 150 on paper using a solid ink printer. Arrows 132′ point to area 140′ of ink region 101. Image 120 depicts the back side of the paper (i.e., the face of the sheet of paper that was not printed). As illustrated in FIGS. 1B and 1C, upon printing digital images 100 and 150, the resolution of the printed lines decreased (compare, e.g., area 140 and area 140′).

FIG. 1D illustrates designs 100 and 150 after printing and subsequent heating. Designs 100 and 150 are illustrated on the front (printed) side of the paper, and corresponding designs 100′ and 150′, respectively, are on the back (nonprinted) side of the paper. Arrows 132″ point to area 140″ of ink region 101 on the front side of the paper after heating. Illustrated as 130′ is a magnification of central region 105′ of design 100′ on the back side of the paper after heating. Arrows 132″′ point to area 140″′ on the back side of the paper. As depicted in FIG. 1D, after heating, the solid ink permeated the thickness of the paper to the back side of the paper. Further, comparing area 140′ (FIG. 1C) to area 140″ (FIG. 1D) demonstrates that heating the solid ink resulted in a spreading of the ink laterally as well as through the thickness of the paper. This is also illustrated in FIG. 1D by dashed lines 180 and 185, which show the original edge of ink regions 101 and 151 (in FIG. 1C), respectively, before heating.

In determining the design and feature sizes of the wax material to be initially disposed onto a substrate, the spreading of molten wax can be accounted for. The spreading of molten wax in paper is a process of capillary flow in porous materials that is described by Washburn's equation (Washburn, Phys. Rev. 17:273-283 (1921)) (eq 1):

L=(γDt/4η)^{1/2} (1)

where L is the distance that a liquid of viscosity η and surface tension y penetrates a porous material with an average pore diameter D in time t. The viscosity of the wax is a function of the temperature, and a uniform and well-controlled heat source can be used for reproducible results. Assuming the paper is kept at a constant temperature throughout the heating step, all of the parameters in eq 1 are fixed, and the distance that the wax will spread in the paper from the edge of the printed line will be constant, regardless of the width of the printed line, so long as the amount of wax is not limiting, as is the case for thin lines. The lateral width of the hydrophobic barrier is thus related to the width of the printed line by eq 2:

W_{B}=W_{P}+2L (2)

where W_{B} is the lateral width of the hydrophobic barrier, W_{P} is the lateral width of the printed line, and L is the lateral distance that the wax spreads from the edge of the printed line (all given in micrometers), in a direction perpendicular to the line. The value of L also can be determined experimentally by measuring the width of printed lines and the width of the resulting hydrophobic barriers.

The width of a hydrophilic channel defined by two parallel hydrophobic barriers can be calculated using eq 3:

W_{C}=W_{G}−2L (3)

where W_{C} is the width of the hydrophilic channel and W_{G} is the space between the two printed lines (also in micrometers), measured on the edge of the line.

Methods of Heating

After the wax material is contacted or disposed onto the hydrophilic substrate, the hydrophilic substrate is subsequently heated to a temperature sufficient to melt the wax material. For example, the heating can result in the wax material spreading through the hydrophilic substrate, substantially permeating the thickness of the hydrophilic substrate and defining hydrophobic barriers within the hydrophilic substrate. Any suitable method for heating the hydrophilic substrate can be used. For example, patterned paper can be heated on a hot plate or in a low temperature oven. Suitable temperatures to melt a wax material disposed onto a porous, hydrophilic substrate can be, e.g., about 45° C., about 50° C., about 60° C., about 70° C., about 80° C., about 90° C., about 100° C., about 110° C., about 120° C., about 130° C., about 140° C., about 150° C., about 160° C., about 170° C., or about 180° C.

Microfluidic Paper-Based Analytical Devices (μPADs) and Uses

The patterned hydrophilic substrates described herein can be used for diagnostics and other analytical applications, such as to detect an analyte of interest. In certain embodiments, μPADs can be made using a process that comprises: i) designing the device using a drawing software; ii) printing the device using a solid-ink printer; iii) melting the initial pattern using a hot surface; iv) applying assay reagents to assay regions of the device; and v) running an assay, e.g., by loading a fluid sample into the device.

In some embodiments, an interaction or complex of a detection reagent and an analyte of interest to be detected within a fluid sample can generate a detectable effect, for example one that is apparent to the naked eye (e.g., detected as a color change). Alternatively, such an interaction can be detected using a spectrometer or other technical means (e.g., to detect a change in ultraviolet absorption).

Typically, the detection reagent has a greater affinity for the predetermined analyte than for other components of the fluid sample to be assayed. The detection reagent can be a chemical, which undergoes a color change when contacted with a particular analyte, or an enzyme that can convert an analyte into a detectable compound or can convert a second agent into a detectable compound in the presence of an analyte.

In some embodiments, the detection reagent is an immunoglobulin, e.g., an antibody, e.g., a primary antibody, that specifically binds to a particular analyte. In some embodiments, a detection antibody, e.g., a secondary antibody, can be loaded onto the diagnostic system after the fluid sample is loaded. When the detection reagent, e.g., primary antibody, specifically binds to an analyte in the fluid and a detection antibody is subsequently loaded onto the diagnostic system, the detection antibody can specifically bind to an analyte bound to the primary antibody and can provide a detectable signal.

The devices described herein can be used for assaying small volumes of biological samples, e.g., fluid samples. Biological samples that can be assayed using the devices described herein include, e.g., urine, whole blood, blood plasma, blood serum, cerebrospinal fluid, ascites, tears, sweat, saliva, excrement, gingival cervicular fluid, or tissue extract. In some embodiments, the volume of fluid sample to be assayed can be a drop of blood, e.g., from a finger prick, or a small sample of urine, e.g., from a newborn or a small animal.

This new patterning capability makes it possible to fabricate devices inexpensively (about $0.01 per device), even when using high quality paper (e.g., chromatography paper). The process is rapid (less than about 5 min from design to finished device) and can produce many copies (e.g., a sheet of 8 inch×12 inch paper can be printed into 100-200 μPADs). This system also provides a test-bed for very large-scale printing process using hydrophobic waxes using, for example, rotogravure printing. Further, devices made of non-specialty paper can be significantly cheaper.

The dimensions for printing a wax material onto a hydrophilic substrate can be determined by one of ordinary skill in the art, and can depend on the hydrophilic substrate, the wax material, and the pattern. For example, in certain embodiments, the printed dimensions for a μPAD can be: i) about 100 μm, about 200 μm, about 300 μm, about 400 μm, about 500 μm or greater in width for a linear barrier, (i.e., to contain the liquid); ii) about 200 μm, about 300 μm, about 400 gm, about 500 μm, about 600 μm, about 700 μm or greater, in width for a circular barrier, (e.g., for a test zone); and iii) a distance of about 500 μm, about 600 μm, about 700 μm, about 800 μm, about 900 μm, about 1000 μm or more, between lateral walls for a channel (i.e., to conduct a solution from an inlet through test zones).

The invention is further described in the following examples, which do not limit the scope of the invention described in the claims.

### EXAMPLES

### Example 1

### Wax Printing Method

### Choice of Paper

Whatman no. 1 chromatography paper was used in most of the examples because it is hydrophilic, homogeneous, pure, reproducible, biocompatible, and available. It is also relatively inexpensive, costing approximately $7/m². Starting from sheets of Whatman No. 1 Chr chromatography (460 mm×570 mm), each sheet was cut into four US Letter size sheets (215 mm×280 mm). This paper size fit directly into the manual feed tray from the printer. Regular print paper and TechniCloth were also used in some instances.

### Choice of Printer and Heat Source

A Xerox Phaser 8560N color printer was used, which prints using a wax-based ink. The print head dispenses ink (melted wax) as liquid droplets of approximately 50-60 μm in diameter on the surface of the paper, where they cool and solidify instantaneously without further spreading. The ink is made of a mixture of hydrophobic carbamates, hydrocarbons, and dyes that melts around 120° C. and is then suitable for piezoelectric printing (see, e.g., U.S. Pat. No. 6,319,310).

A digital hot plate was used to heat the patterned paper. This type of hot plate provides a flat, uniformly heated surface for heating the paper. Other heat sources, such as ovens or heat guns, can also be used for wax patterning

### Designing and Printing of the Devices

A drawing software (CleWin®, PhoeniX Software, The Netherlands) was used to design the wax printing pattern. However, any drawing software can be used. CleWin generates PostScript files, which were converted into a PDF file for printing. The final image preserved the designed dimensions with less than about 10% variation of the intended feature size. The default printer settings for photo-quality printing were used.

### General Preparation of the Devices

FIG. 1 illustrates an exemplary wax printing method. FIG. 1A depicts a schematic representation of the basic steps (1-3) used for wax printing. FIG. 1B is a digital image of a test design. The central area of the design was magnified to show the smaller features. FIG. 1C illustrates images of the test design printed on Whatman no. 1 chromatography paper using the solid ink printer. The front and back faces of the paper were imaged using a desktop scanner. FIG. 1D are images of the test design after heating the paper. The dashed white lines indicate the original edge of the ink. The white bars in the insets highlight the width of the pattern at the position indicated by the arrows.

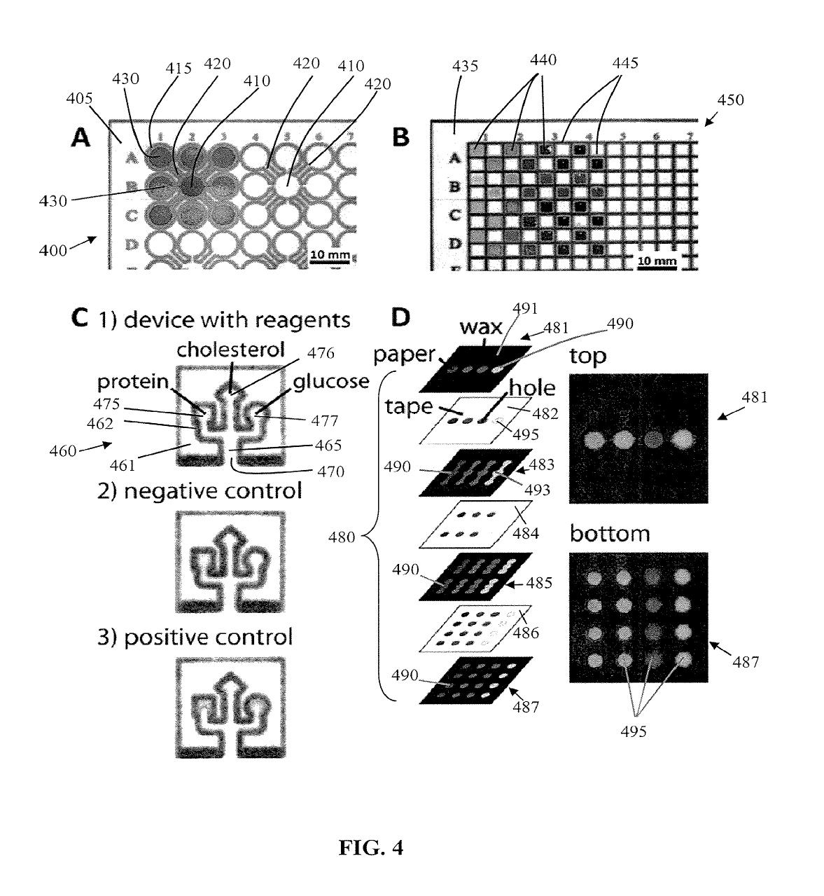

Placing the printed paper on a hot plate set at 150° C. for two minutes reflowed the ink on the paper. The paper was flipped over a couple of times after one minute over the hot plate. Most devices were used for investigatory function and were ready for use after the melting step without addition of any chemicals. Multi-zone paper plates such as shown in FIG. 4A and 4B were also ready for use right off the hotplate. For functional μPADs, such as the example shown in FIG. 4C, it was necessary to add chemicals to the test zones before using the device.

Measuring the Spreading of Molten Wax in Paper

A series of lines of varying widths (100-800 μm, in increments of 100 μm) was designed and printed on paper. The paper was then heated to melt the wax into the paper, and then the cross sections of the resulting hydrophobic barriers were analyzed. For each line, the nominal width (the width of the line as designed on the computer), the printed width (the width of the line as printed on paper), and the barrier width (the average of the width of the hydrophobic barrier on the front face of the paper and back face of the paper) were determined.

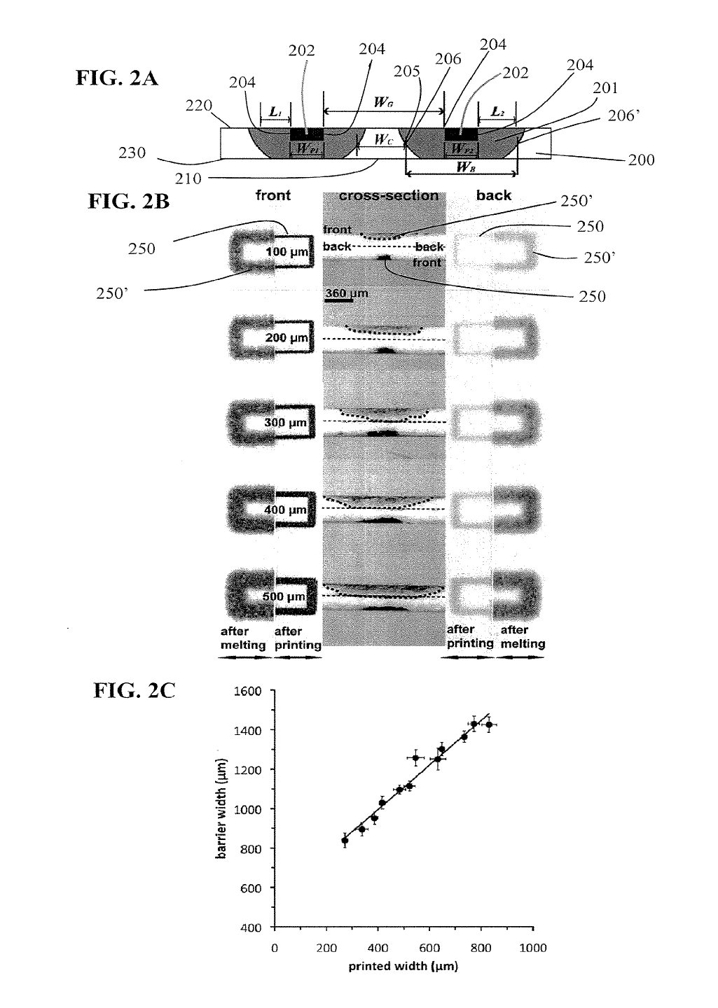

FIG. 2 illustrates the spreading of wax in paper to form hydrophobic barriers. FIG. 2A is a schematic representation of the spreading of molten wax 201 in paper 200 having a front (printed) face 220 and a back (nonprinted) 230 face, and definition of the variables for rational design of μPADs: W_{P} is the printed width of line 202, W_{G} is the separation (or gap) between edges 204 of lines 202 before melting, W_{B} is the thickness of hydrophobic barrier 201 defined as the distance between middle points 206 and 206′ between the front and back widths (i.e., between the lateral widths on front face 220 and back face 230) (average width), W_{C} is the width of the resulting hydrophilic channel 210 after melting of the wax, also defined at the average between the front and back values (i.e., the average width of channel 210 at front face 220 and at back face 230), and L is the spreading of the wax in relation to the original edge 204 of line 202. The black rectangles represent the wax lines 202 before the heating step, and the gray area represents the wax 201 after the heating step.

FIG. 2B are optical micrographs comparing the front, back, and cross-sectional view of printed horizontal lines “before” and “after” the melting process. The top panel of FIG. 2B shows the thickness and spreading of a line having a printed width of 100 μm before melting (line 250) and after melting (line 250′). The remaining panels show similar lines having printed widths of 200-500 μm before melting. FIG. 2C is a quantitative assessment of the spreading of molten wax in chromatography paper. The values represent the average (n=10) of the measured barrier widths, and a linear fit yielded W_{B}=1.1 W_{P}+550, R²=0.97. The error bars represent 1 standard deviation in both axes (n=10).

The average spreading of wax in paper (L) was found to be 275 μm for lines with nominal widths ≧300 μm. The measured printed width differed from the nominal width by as much as 10% of the nominal width, and the average printed width was about 30 μm larger than the nominal width for vertical lines and about 25 μm smaller than the nominal width for horizontal lines. This difference indicated a bias in the orientation of printing. Hydrophobic barriers from lines with nominal widths less than 300 μm did not contain enough wax to span the entire thickness of the paper, and were not considered in the model. FIG. 2B compares side-to-side lines of 100-500 μm before and after the melting process. Analysis of the cross-section of these lines provided the insight for the proposed model for the spreading of molten wax in paper. FIG. 2C shows that the width of the barrier was linearly dependent on the printed width (Wp) as predicted by eq 2 (described herein).

### Example 2

### Resolution of Wax Printing Method

To define the resolution of the wax printing method, the barrier width of the narrowest functional hydrophobic barrier and the channel width of the narrowest functional hydrophilic channel were determined experimentally. A functional hydrophobic barrier was defined as one that prevented water from wicking across it for at least 30 min. A functional hydrophilic channel was defined as one that was at least 5 mm long and wicked aqueous solutions from a fluid reservoir to a test zone.

Many design of the devices in different shapes, orientations, line thickness, and line spacing were tested to allow easy and simple visualization if the features, i.e., lines, gaps, and circles, could function as barriers, channels, and reservoirs, respectively. Analysis of the effectiveness of the hydrophobic barriers and hydrophilic channels were visual, using a solution of 5 mM of Amaranth [CAS number 915-67-3]. The presence of leaks indicated that the barrier was not effective at a given line thickness; blockage of the solution was an indication that the spacing between two lines were too close to leave a channel for wicking of the solution. All line thickness and distances were measured using an optical microscope (Leica MZ12) and a 1-mm scale, or using the ruler tool from Adobe Acrobat on images acquired with a desktop scanner (Epson Perfection) with resolution of 300 dpi or greater.

To determine the narrowest functional hydrophobic barrier, a series of test barriers was fabricated having nominal widths ranging from 100 to 600 μm, in increments of 100 μm. Horizontal straight lines (i.e., parallel to the arrangement of the printing nozzles), vertical straight lines (i.e., perpendicular to the arrangement of the printing nozzles), and circles were tested. To determine the narrowest functional hydrophilic channel, a series of channels defined by two parallel lines with nominal widths of 400 μm was fabricated. The nominal space between the two lines was varied from 400 μm to 1.1 mm, in increments of 100 μm.

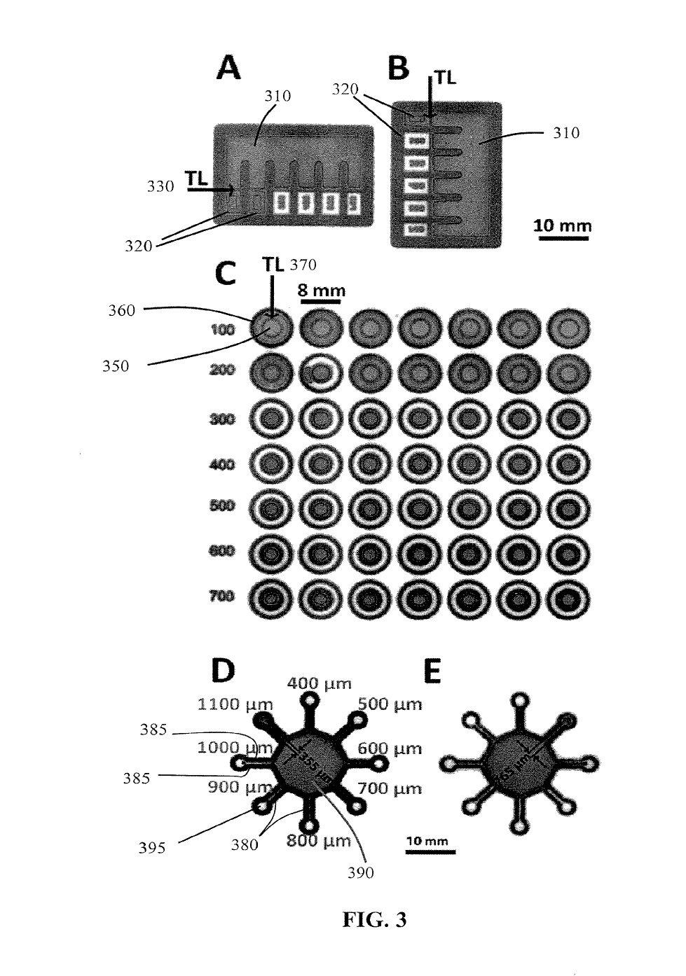

As depicted in FIGS. 3A and 3B, for vertical and horizontal hydrophobic barriers, a device was fabricated with a central fluid reservoir 310 and six test zones 320. Each test zone 320 was separated from fluid reservoir 310 by a hydrophobic barrier 330 indicated as the test line (TL). The features inside test zones 320 were the nominal widths of the barriers (in micrometers), which were blurred during the heating step.

FIG. 3C illustrates an assay for circular hydrophobic barriers. As depicted in FIG. 3C, a circular fluid reservoir 350 was separated from concentric circular test zone 360 by hydrophobic barrier 370. In FIG. 3D, the smallest functional hydrophilic channel was determined by testing channels 380 with a range of gap widths (400-1100 μm, in 100 μm increments) defined by hydrophobic barriers 385 of constant nominal width (400 μm). Channels 380 separated central fluid reservoir 390 from test zones 395. FIG. 4E depicts an image of the back face of the device shown in FIG. 4D. The values shown in gray are the nominal gap widths. The numbers shown in black are the average channel widths (n=12) measured after the heating process.

The smallest functional hydrophobic barriers had nominal widths of 300 μm, which resulted in an average barrier width of 850±50 μm (n=10). These results agreed well with our model, which predicted a barrier width of 850 μm. Barriers with nominal widths ≧300 μm generated functional hydrophobic barriers in 100% of the experiments, regardless of the orientation of the line (n=7 for horizontal and vertical lines, n=75 for circles) (FIG. 3A-C). The 200 μm wide test line showed some differences in the results for the horizontal, vertical, and circular lines, confirming a bias in the orientation of printing: the 200 μm wide vertical test lines generated functional barriers in 86% of the experiments (n=7), while the 200 μm wide horizontal and circular test lines generated functional barriers in only 14% of the experiments (n=7 for horizontal lines, n=75 for circles). Finally, none of the 100 μm-wide test lines yielded functional hydrophobic barriers (n=7 for straight and vertical lines, n=75 for circles). These results were for printed Whatman grade 1 Chr paper (180 μm thick), and can readily be determined for other papers.

The smallest functional hydrophilic channel had an average width of 561±45 μm (n=12) and came from two printed lines separated by a nominal width of 1100 μm (FIGS. 3D and 3E). These results also agreed well with our model described in eq 3 (described herein), which predicted a channel width of 550 μm for two lines separated by 1100 μm.

The resolution of wax printing was coarse, i.e., the boundaries between hydrophilic and hydrophobic regions on the paper were not sharp. The root-mean-square (rms) roughness at the edge of a 300 μm line, after melting, was approximately 57 μm. The resolution was limited by the quality of the paper (thickness, porosity, and orientation of fibers). The mass transport of the wax in the perpendicular direction (through the plane of the paper) was improved by applying an external force, such as vacuum driven flow of air, on the direction of the flow (results not shown). Additionally, printing a pattern on both sides of the paper leads to smaller and more highly resolved barriers, with careful alignment of the patterns.

### Example 3

### Wax Printing and Solvent Compatibility

Wax-printed μPADs are compatible with aqueous solutions. Aqueous solutions of various pHs, acids (sulfuric acid, 30%, and hydrochloric acid, 1 N), bases (sodium hydroxide, 0.1 N), and glycerol (pure or in solution) wick along the hydrophilic channels but do not cross the hydrophobic barriers, even with a large excess of fluid. Strong acid and base solutions dissolve the paper if the device is left in the solution for long periods of time (days).

Wax-printed channels were not compatible with organic solvents. Xylenes, acetone, methylene chloride, mineral oil, and alcohols (methanol, ethanol, and n-propanol) all wicked through the hydrophobic barriers. Dichloromethane and acetone washed away most of the dye in the wax and carried it along with the front of the solvent, but after the solvent evaporated, the hydrophobic barriers were still present. Based on this permeability to organic solvents, in one embodiment, biological samples are applied onto a 96-zone paper plate and, after the samples are dry, the samples are washed with an organic solvent to remove endogenous and exogenous interferences for a given bioassay.

### Example 4

### Microfluidic Paper-Based Analytical Devices Made by Wax Printing Preparation of Devices for Bioassays

Reagents for a protein assay, a cholesterol assay and a glucose assay were added to each test zone of a μPAD as follows.

Protein Assay. A priming solution (0.2 μL, 250-mM citrate buffer, pH 1.8, prepared in 92% water and 8% ethanol by volume) was spotted in the protein test zone using a micro-pipette (VWR) and was allowed to dry for 10 min at ambient temperature. A reagent solution (0.2 μL, 9-mM tetrabromophenol blue prepared in 95% ethanol and 5% water by volume) was spotted on top of the priming solution and dried for 10 min under ambient conditions.

Cholesterol Assay. A reagent solution [cholesterol oxidase-horseradish peroxidase (200 units of cholesterol oxidase enzyme activity and 30 units of horseradish peroxidase enzyme activity per mL of solution), 0.6-M potassium iodide, and 0.3-M trehalose in a pH 7.0 phosphate buffer prepared in Millipore-purified water] was spotted in the cholesterol test zone using a micro-pipette and allowed to dry under ambient conditions.

Glucose Assay. A reagent solution [glucose oxidase-horseradish peroxidase (120 units of glucose oxidase enzyme activity and 30 units of horseradish peroxidase enzyme activity per mL of solution), 0.6-M potassium iodide, and 0.3-M trehalose in a pH 6.0 phosphate buffer prepared in Millipore-purified water] was spotted in the glucose test zone using a micro-pipette and allowed to dry under ambient conditions.

### Performing Bioassays

A negative control solution (phosphate buffer saline, pH 7.4), and a positive control solution (15-μM bovine serum albumin (BSA), 40-mM cholesterol, and 5-mM glucose prepared in PBS, pH 7.4) were prepared, and 5 μL of each sample was transferred to a Petri dish using a micro-pipette. The bottom of the device was dipped into each solution (˜5 μL), and the device wicked the solution into the test zones. After remaining upright in the Petri dish for 30 min, the devices were scanned using an Epson Perfection 1640SU scanner on default settings (color photo, 600 dpi).

Four examples of μPADs were fabricated having different designs and functions to demonstrate that wax printing is capable of generating paper-based multizone plates (see, e.g., Carrilho et al., Anal. Chem. 81:5990-5998 (2009)), lateral-flow devices (see, e.g., Martinez et al., Angew. Chem. Int. Ed. 46:1318-1320 (2007)), and three-dimensional (3D) μPADs (see, e.g., Martinez et al., Proc. Natl. Acad. Sci. U.S.A. 105:19606-19611 (2008)).

FIG. 4A shows a paper-based multizone plate 400 having 96 zones. Multizone plate 400 includes paper substrate 405 having a plurality of assay units, each having a central zone 410 in fluid connection to 8 assay zones 430 by microfluidic channels 420. Wax material defines liquid impervious, hydrophobic boundary 415. FIG. 4B shows a paper-based multizone plate 450 having 384 zones 440 on paper substrate 435. Wax material defines liquid impervious, hydrophobic boundaries 445. Plates 400 and 450 are compatible with plate readers for quantitative analysis in both absorbance and fluorescence modes (see, e.g., Carrilho et al., Anal. Chem. 81:5990-5998 (2009)). Fabrication of multizone paper plates required only printing lines thick enough to hold a large excess of liquid within the zones, which was 500 μm in these examples. Wax printing took less than 3 min to prepare four multizone plates, while photolithographic methods require about 20 min to prepare a single plate (see, e.g., Carrilho et al., Anal. Chem. 81:5990-5998 (2009)).

As depicted in FIG. 4A, when a 45 μL solution of Amaranth in water was applied to central zone 410 of multizone plate 400, the liquid distributed itself homogeneously into all eight surrounding zones 430 via channels 420. FIG. 4B illustrates the application of 1-8 μL of aqueous dyes to alternating zones 440 of multizone plate 450.

FIG. 4C depicts a lateral-flow μPAD 460 that was fabricated for colorimetric detection of protein, cholesterol, and glucose in biological fluids, using wax material. Similar μPADs made by different methods are described in, e.g., Martinez et al., Lab Chip 8:2146-2150 (2008); and Martinez et al., Angew. Chem. Int. Ed. 46:1318-1320 (2007). Device 460 included paper substrate 461 and liquid impervious, hydrophobic boundary 462 made my wax printing. Device 460 also included central inlet channel 465 that wicked a fluid sample from the bottom 470 of the device and distributed it into three independent test zones 475, 476, and 477 that were prespotted with reagents for the assays. The reagents for each assay were added to test zones 475, 476, and 477 before the device was used. The negative control wicked a phosphate buffer saline solution (PBS), while the positive control wicked a solution containing 15 μM bovine scrum albumin (BSA), 40 mM cholesterol, and 5 mM glucose in PBS.

FIG. 4D illustrates a 3D μPAD fabricated using wax printing described herein. Similar 3D μPADs, but made by different methods, have been described by, e.g., Martinez et al., Proc. Natl. Acad. Sci. U.S.A. 105:19606-19611 (2008). As shown in FIG. 4D, device 480 was made by stacking alternating layers of paper 481, 483, 485, and 487 and tape 482, 484, and 486. Each layer of paper included a liquid impervious, wax barrier 491 that defined a hydrophobic barrier surrounding hydrophilic regions 490. The tape layers include holes 495 that allow a fluid sample to flow from one paper layer three-dimensionally to another paper layer in the stack. For example, fluid deposited in hydrophilic region 490 of paper layer 481 can flow through hole 495 of tape layer 482 into hydrophilic region 493 of paper layer 483. In this way, a fluid can flow from top layer 481 to bottom layer 487. Device 480 thus distributed four individual samples (visualized as aqueous dyes) from inlets on top layer 481 into an array of 16 test zones 495 on bottom layer 487.

1.-21. (canceled)

22. A method of manufacturing a microfluidic analytical device, the method comprising:
providing a porous, hydrophilic substrate that permits liquid movement;
disposing a wax material onto the substrate in a predetermined pattern defining an assay region; and
heating the wax material to a temperature sufficient to melt the wax material thereby to permeate substantially through the thickness of the substrate, to define a pattern of one or more fluid impervious barriers in the substrate.

23. The method of claim 22 wherein, after heating, the wax material permeates the entire thickness of the substrate.

24. The method of claim 22 wherein the substrate is patterned into an array of assay units.

25. The method of claim 22 further comprising adding an assay reagent to the substrate.

26. The method of claim 22 wherein a fluid impervious barrier further defines a boundary of a channel region fluidically connected to the assay region within the substrate.

27. The method of claim 22 wherein a fluid impervious barrier further defines a boundary of a sample deposition region within the substrate and a channel region providing a fluidic pathway within the substrate between the sample deposition region and the assay region.

28. The method of claim 22 wherein a fluid impervious barrier further defines boundaries of a plurality of assay regions.

29. The method of claim 22 further comprising placing a plurality of patterned substrates in a layered stack that permits liquid movement three-dimensionally from one substrate layer to another substrate layer in the stack.

30. The method of claim 26 wherein the wax material is further disposed within the channel region.

31. The method of claim 22 comprising providing a substrate comprising paper.

32. The method of claim 32 wherein the paper is chromatography paper.

33. The method of claim 32 further comprising providing a plurality of sheets of paper.

34. The method of claim 22 wherein the disposing step comprises hand drawing, printing, or stamping.

35. The method of claim 34 wherein the disposing step comprises printing using a solid ink printer.

36. A method of manufacturing a microfluidic paper-based analytical device, the method comprising:
providing a paper substrate that permits liquid movement;
printing a solid ink onto the paper substrate in a predetermined pattern defining an assay region using a solid ink printer; and
heating the solid ink to a temperature sufficient to melt the solid ink thereby to permeate substantially through the thickness of the paper substrate, to define a pattern of one or more fluid impervious barriers in the paper substrate.

37. The method of claim 36 further comprising providing a plurality of sheets of paper and printing solid ink onto each sheet of paper in a predetermined pattern defining an assay region using a solid ink printer.

38. The method of claim 36 wherein the paper substrate is chromatography paper.

39. The method of claim 36 wherein the paper substrate is patterned into an array of assay units.

40. The method of claim 36 further comprising adding an assay reagent to the paper substrate.

41. The method of claim 36 wherein a fluid impervious barrier further defines a boundary of a channel region fluidically connected to the assay region within the paper substrate.

42. The method of claim 36 wherein the fluid impervious barrier further defines a boundary of a sample deposition region within the paper substrate and a channel region providing a fluidic pathway within the paper substrate between the sample deposition region and the assay region.

43. The method of claim 36 further comprising placing a plurality of patterned paper substrates in a layered stack that permits liquid movement three-dimensionally from one substrate layer to another substrate layer in the stack.

44. A microfluidic analytical device manufactured by the method of claim 22.

45. A microfluidic paper-based analytical device manufactured by the method of claim 36.

46. A microfluidic analytical device, comprising:
a porous, hydrophilic substrate that permits liquid movement;
a pattern of fluid impervious barriers comprising a wax material substantially permeating the thickness of the substrate thereby defining an assay region; and
an assay reagent disposed within the substrate.

47. The device of claim 46 wherein a fluid impervious barrier further defines a boundary of a channel region fluidically connected to the assay region within the substrate.

48. The device of claim 46 wherein a fluid impervious barrier further defines a boundary of a sample deposition region within the substrate and a channel region providing a fluidic pathway with the substrate between the sample deposition region and the assay region.

49. The device of claim 46 wherein a fluid impervious barrier further defines boundaries of a plurality of assay regions.

50. The device of claim 46 wherein the wax material is further disposed within the channel region.

51. The device of claim 46 wherein the substrate comprises paper.

52. The device of claim 51 wherein the paper is chromatography paper.

53. The device of claim 46 further comprising a plurality of patterned substrates in a layered stack that permits liquid movement three-dimensionally from one substrate layer to another substrate layer in the stack.
